(19) United States
(12) Patent Application Publication
(10) Pub. No.: US 2004/0109266 A1
(43) Pub. Date: Jun. 10, 2004

(54) Anachronic relay

(76) Inventor: Aria Sabahi, Los Angeles, CA (US)

Correspondence Address: ARIA SABAHI, 2134 S. Bentley Ave., #2, Los Angeles, CA, 90025, US

(21) Appl. No.: 10/198,165

(22) Filed: Dec. 10, 2002

(51) Int. Cl. H02H 7/00

(52) U.S. Cl. 361/2

(57) ABSTRACT

This is a solid state electronic device for retrieving bits of data from the future to the present. It uses a circular chain of conductor arcs to cause the magnetic flux of current pulses to travel faster than light and thus in negative time. The negative time flux fields are next picked up by antennae of conductor which are connected to driver circuits to introduce a current pulse to the next arc.

### I.BASIS

According to Einstein's special theory of relativity, the formula for time dilation is

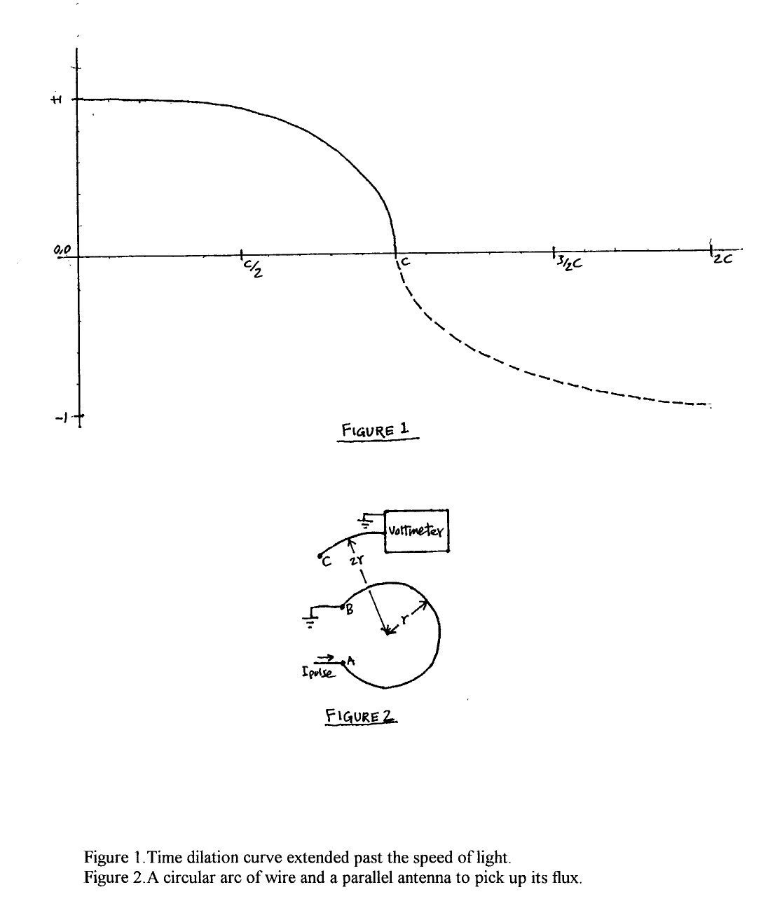

t'=t1−(v/c)

where t is the rate of progression of time of an object at rest, t' is the rate of progression of time of the moving object, v is the velocity of the object, and c is the speed of light. The curve for time dilation is plotted as the solid line in FIG. 1. We assume that the curve continues into negative time, as shown by the broken line.

In order for something to experience negative time, it must travel faster than the speed of light. Unfortunately, according to Einstein's special theory of relativity, it would take an infinite amount of energy to accelerate a quantity of mass past the speed of light. However, magnetic flux has zero mass and it would take zero energy to accelerate it past the speed of light.

In FIG. 2 a length of wire has been arranged in the shape of an arc of a circle. When a pulse of current is introduced in point A the magnetic flux on the outside of the arc, at about radius 2r, starts going back in time with a time dilation close to −1 and it goes around the center towards point C where it causes a very small voltage in the antenna shown parallel to the arc. The voltmeter will show the small voltage an instant before the pulse of current reaches point B. In this way our signal will have achieved negative time traversal.

The period of time traveled in reverse is given by

P=L/30 nanoseconds

Where L is the length of the arc in centimeters.

Using this arc and antenna we can send one bit of information to the past. If a current pulse is introduced at point A, a digital 1 is sent, and if no current pulse is introduced, a digital 0 is sent.

### II.DESIGN:

In order to achieve continuous negative time traversal we must build a chain of arcs and antennae, with the proper circuits in between to drive the arcs. This chain must lead back to the original arc with the sum of net negative time traversed greater than the amount of time it takes for the subcircuit to introduce a pulse of current to the arc and for that pulse to reach the end of the arc.

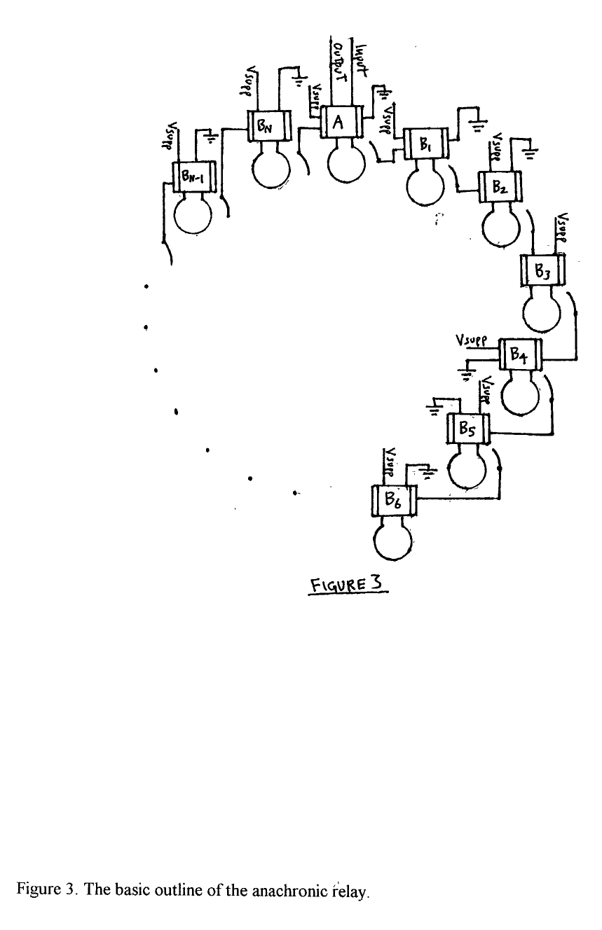

The design for this device is shown in FIG. 3.

Here, subcircuit A reads an input signal; if it is a digital 1, it introduces a pulse of current to its arc wire; if the input is digital zero, it does nothing. Also, if its antenna picks up a signal, it introduces a current pulse to its arc, and if the antenna doesn't pick up a digital 1, it does nothing. Each time this circuit introduces a current pulse to its arc, it also outputs a digital 1 on its output line, at all other times it outputs a digital 0 on its output line.

Subcircuits B through B introduce a current pulse to their arc when they detect a signal in their antenna, and do nothing at all other times. These must be designed such that the time of operation of each subcircuit is briefer than the negative time it achieves in linking with the next circuit.

The number N of subcircuits B is selected such that the sum of negative time traversals achieved minus the times of operation of the subcircuits B is greater than the time circuit A takes to operate.

The device is operated by turning it on (providing power supply). Then some time afterwards an operator inputs either a digital 1 or a digital 0 into subcircuit A. Immediately after being turned on the device outputs the same bit of information through subcircuit A, having retrieved it from the future.

Depending on the quality of the circuit, information from months or years in the future can be retrieved into the present.

1. What I claim as my invention is: a device which can electronically retrieve one bit of data from the future to the present.
